(19) United States
(12) Patent Application Publication
(10) Pub. No.: US 2005/0161605 A1
(43) Pub. Date: Jul. 28, 2005

(54) Infrared gas sensor

(75) Inventors: Hisanori Yokura, Chiryu-city (JP); Yasutoshi Suzuki, Okazaki-city (JP); Takahiko Yoshida, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/019,261

(22) Filed: Dec. 23, 2004

(30) Foreign Application Priority Data
Jan. 26, 2004 (JP) 2004-17427

(51) Int. Cl. G01N 21/35

(52) U.S. Cl. 250/343

(57) ABSTRACT

An infrared gas sensor includes: an infrared light source having a resistor for emitting an infrared light by heating the resistor; an infrared light sensor having a detection device for generating an electric signal in accordance with a temperature change of the detection device corresponding to the infrared light in a case where the sensor receives the infrared light; a reflection member for reflecting the infrared light emitted from the light source to introduce the infrared light to the sensor; a casing for accommodating the light source, the light sensor, and the reflection member; and a substrate. The reflection member faces the light source. The resistor and the detection device are disposed on the substrate.

### CROSS REFERENCE TO RELATED APPLICATION

This application is based on Japanese Patent Application No. 2004-17427 filed on Jan. 26, 2004, the disclosure of which is incorporated herein by reference.

### FIELD OF THE INVENTION

The present invention relates to an infrared gas sensor.

### BACKGROUND OF THE INVENTION

Conventionally, for example, there is known the infrared gas sensor as disclosed in Japanese Patent Application Publication No. H9-184803. This infrared gas sensor comprises an infrared source, an infrared sensor to detect infrared light, and a reflection member disposed opposite to the infrared source to apply the reflected infrared light to the infrared sensor, all contained in the same case.

The infrared gas sensor (hereafter referred to as the gas sensor) provides a light source (infrared source) opposite to a concave reflecting mirror (reflection member). A light receiver (infrared sensor) is provided at or near a position to converge a flux of reflected infrared light radiated from the light source. Gas containing gas under test is filled in spaces between the light source, the light receiver, and the concave reflecting mirror to measure ratios of absorbing the infrared light by means of the gas.

However, the gas sensor in Japanese Patent Application Publication No. H9-1874803 is provided with the light source and the light receiver separately (on different chips). It is difficult to miniaturize the gas sensor size.

In such gas sensor, increasing the amount of infrared light energy applied to the infrared sensor also increases changes in output from the infrared sensor. Thus, the gas sensor sensitivity improves. However, the gas sensor needs to position the light source and the light receiver with reference to the concave reflecting mirror. The installation positions are easily subject to errors. Accordingly, variations in the installation positions change the infrared light energy amount to be applied to the light receiver. The sensor sensitivity may vary.

### SUMMARY OF THE INVENTION

In view of the above-described problem, it is an object of the present invention to provide an infrared gas sensor having a small size and stable sensitivity.

An infrared gas sensor includes: an infrared light source having a resistor for emitting an infrared light by heating the resistor; an infrared light sensor having a detection device for generating an electric signal in accordance with a temperature change of the detection device corresponding to the infrared light in a case where the sensor receives the infrared light; a reflection member for reflecting the infrared light emitted from the light source to introduce the infrared light to the sensor; a casing for accommodating the light source, the light sensor, and the reflection member; and a substrate. The reflection member faces the light source. The resistor and the detection device are disposed on the substrate.

In the above sensor, the resistor and the detection device are disposed on the same substrate, i.e., they are integrated on the same substrate. Accordingly, the arrangement of the resistor, i.e., the light source and the detection device, i.e., the light sensor can be compact. Thus, the dimensions of the gas sensor become smaller.

Further, since the resistor and the detection device are disposed on the same substrate so that their positioning relationship is predetermined, the positioning accuracy between the light source and the light sensor can be improved, compared with a sensor having the light source and the sensor chip individually disposed on different substrates. Thus, the deviation of the sensor sensitivity is reduced.

Preferably, the reflection member is a concave mirror. In this case, amount of the infrared light reaching the light sensor, i.e., a coefficient of a received infrared light becomes larger with using the concave mirror so that the sensor sensitivity is increased. Further, the deviation of the sensor sensitivity is improved.

Preferably, the substrate includes a plurality of membranes as a thin portion of the substrate. The resistor and the detection device are disposed on different membranes, respectively. In this case, the resistor and the detection device are thermally isolated from the substrate. Therefore, the infrared light source can emit the infrared light effectively, and further, the infrared light sensor has a large sensor output.

Preferably, the detection device is a thermocouple including a measurement junction and a reference junction. The measurement junction is disposed on one membrane, and the reference junction is disposed on the substrate except for the membrane.

Preferably, the detection device has a part made of the same material as the resistor. Further, the detection device has a part, which is disposed on the same plane as the resistor. In this case, the manufacturing process can be simplified. Specifically, when the detection device and the resistor are formed of the same material to be disposed on the same plane, both the resistor and the detection device are formed in the same process at the same time so that the manufacturing process is simplified. Thus, the manufacturing cost of the sensor is reduced.

Preferably, the substrate is a semiconductor substrate, and the resistor and the detection device are disposed on the semiconductor substrate through an insulation film. In this case, the resistor and the detection device are formed with high positioning accuracy by a conventional semiconductor process method. Thus, the gas sensor with high sensor sensitivity can be formed with low cost.

Preferably, the sensor further includes a circuit chip. The substrate having the resistor and the detection device is mounted on the circuit chip so that the circuit chip with the substrate is disposed inside the casing. Specifically, when the resistor and the detection device are formed on the same substrate, the arrange areas of the infrared light source and the infrared light sensor becomes smaller. Therefore, the circuit chip for operating the infrared light source and the infrared light sensor can be accommodated in a space of the casing.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a gas sensor according to a preferred embodiment of the present invention;

FIG. 2A is a plan view showing a sensor chip, and FIG. 2B is a cross sectional view showing the sensor chip taken along line IIB-IIB in FIG. 2A, according to the preferred embodiment;

FIG. 3 is a cross sectional view showing a sensor chip of a gas sensor according to a modification of the preferred embodiment; and

FIG. 4 is a schematic view showing a gas sensor according to another modification of the preferred embodiment.

### DETAILED DESCRIPTION OF THE PREFERRED EMBODIMENT

Embodiments of the present invention will be described in further detail with reference to the accompanying drawings. The present invention is applied to infrared gas sensors having a so-called reflective structure. In such infrared gas sensor, an infrared source radiates infrared light. A reflection member is disposed opposite to the infrared source and reflects the infrared light. An infrared sensor detects the reflected light.

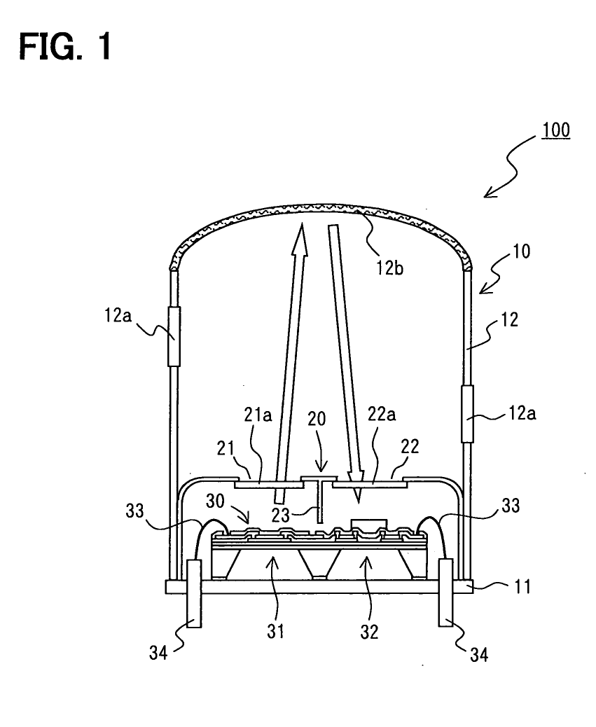

FIG. 1 schematically shows the configuration of an infrared gas sensor (hereafter referred to as a gas sensor) according to a preferred embodiment of the present invention.

As shown in FIG. 1, a gas sensor 100 has a reflection member to reflect infrared light and comprises a case 10, a cap 20, and a sensor chip 30. The case 10 is provided so that gas under test can enter. The cap 20 is disposed in the case 10 and limits the infrared light. The sensor chip 30 is disposed in the case 10. The sensor chip 30 is configured to be an integration of an infrared source to radiate infrared light and an infrared sensor to detect infrared light.

The case 10 comprises a pedestal 11 as a base and a cylindrical container 12 attached to the pedestal 11.

The container 12 has a plurality of gas entry/exits 12a (two in FIG. 1) on the side. The gas entry/exit 12a enables gas containing the gas under test to flow into the case 10. The case 10 contains a concave mirror 12b on the inside top surface opposite to the pedestal 11. The concave mirror 12b functions as a reflection member to reflect infrared light. The concave mirror 12b is shaped to have a specified radius. This aims at reflecting infrared light radiated from the infrared source of the sensor chip 30 and applying the infrared light to the infrared sensor of the sensor chip 30. The infrared source and the infrared sensor will be described later.

The cap 20 limits directions of infrared light radiated from the infrared source. In addition, the cap 20 limits an incident region on the sensor chip 30 for the infrared light reflected by the concave mirror 12b. The cap 20 is configured to shield infrared light except a radiation window 21 and an incident window 22. The radiation window 21 is positioned correspondingly to the infrared source. The incident window 22 is positioned correspondingly to the infrared sensor. The radiation window 21 is provided with an infrared light transmission filter 21a. The incident window 22 is provided with a band-pass filter 22a to selectively transmit the infrared light having a specific wavelength only. The cap 20 has a partition wall 23 extending form the top toward the surface of the sensor chip 30. When the infrared source isotropically radiates the infrared light, the partition wall 23 prevents the radiated infrared light from directly entering the infrared sensor inside the cap 20.

The sensor chip 30 is fixed on the pedestal 11 in the case 10 and has a light source section 31 and a light receiving section 32 on a single chip. The light source section 31 works as an infrared source that radiates infrared light. The light receiving section 32 works as an infrared sensor to receive the infrared light that is radiated from the light source section 31 and is reflected on the concave mirror 12b. That is, the light source section 31 and the light receiving section 32 are integrated on the sensor chip 30 as a single chip. This makes it possible to reduce the space for mounting the light source section 31 and the light receiving section 32 in the case 10. The size of the gas sensor 100 can be minimized.

As mentioned above, the light source section 31 and the light receiving section 32 are integrated on the sensor chip 30 as a single chip. This predetermines positional relationship between the light source section 31 and the light receiving section 32. Accordingly, the light source section 31 and the light receiving section 32 can be disposed on the pedestal 11 of the case 10 just by positioning the sensor chip 30 against the concave mirror 12b. This improves the accuracy of positioning the light source section 31 and the light receiving section 32 against the concave mirror 12b. That is, this decreases variations of the infrared light energy applied to the light receiving section 32. Consequently, it is possible to decrease variations of the sensor sensitivity for each gas sensor 100.

In particular, as a reflection member, the concave mirror 12b having a specified radius may be used to increase the infrared light energy amount (i.e., the infrared light receiving efficiency) applied to the light receiving section 32. The positional accuracy for the light source section 31 and the light receiving section 32 greatly affects variations of the sensor sensitivity. According to the construction presented in this embodiment, the use of the concave mirror 12b can increase the infrared light receiving efficiency (i.e., the sensor sensitivity) and decrease variations of the sensor sensitivity. The sensor chip 30 will be described later in more detail.

The sensor chip 30 is electrically connected to a terminal 34 via a bonding wire 33. The terminal 34 works as a fixed external output terminal that pierces through the pedestal 11.

In this manner, the gas sensor 100 according to the embodiment is provided with the concave mirror 12b on the top inside surface of the case 10. The sensor chip 30 is provided with the light source section 31 and the light receiving section 32. The sensor chip 30 is disposed on the pedestal 11 for the case 10 with high positional precision against the concave mirror 12b. The infrared light is radiated from the light source section 31, passes through the infrared light transmission filter 21a attached to the radiation window 21, and is reflected on the concave mirror 12b. The band-pass filter 22a is attached to the incident window 22 of the cap 20 and transmits only the infrared light having a specified wavelength out of the reflected light. The transmitted infrared light efficiently reaches the light receiving section 32.

The infrared light goes back and forth in the gas under test that flows into the case 10 (except the inside of the cap 20) through the gas entry/exit 12a. Meantime, the infrared light having the specified wavelength is absorbed and the remaining infrared light reaches the light receiving section 32. At this time, the density of the gas under test changes the intensity of the infrared light that reaches the light receiving section 32. An output from the light receiving section 32 changes accordingly to measure the gas undertest. Since this reflective construction extends the optical path length of the infrared light, the sensor sensitivity can be improved.

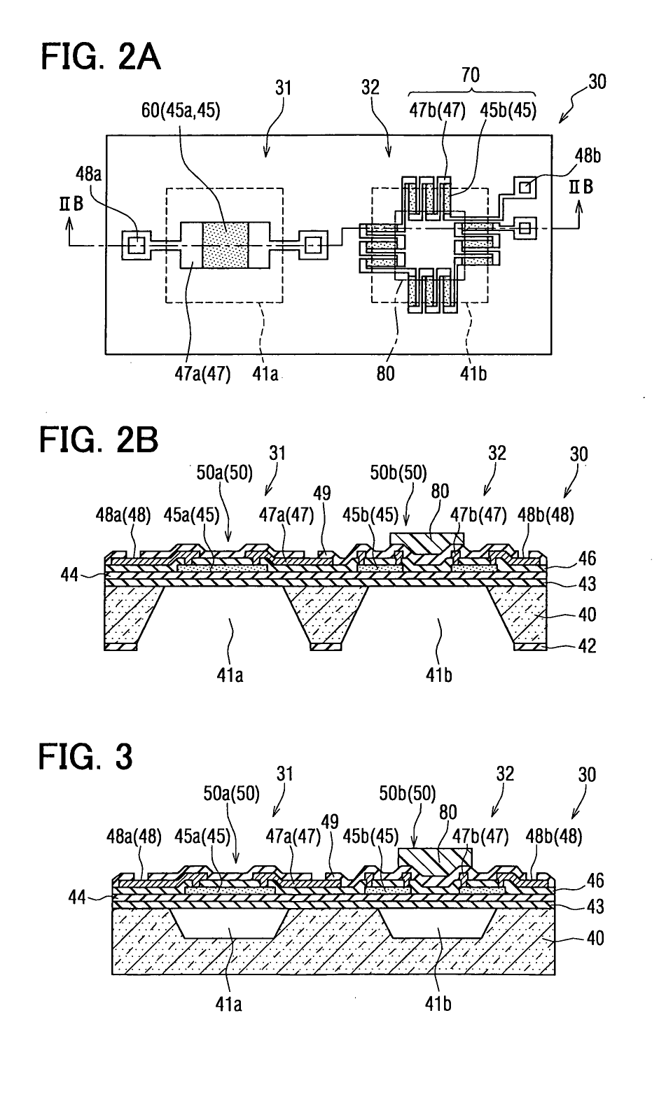

The construction of the sensor chip 30 will be described with reference to FIGS. 2A and 2B. FIGS. 2A and 2B show enlarged details of the sensor chip 30 in FIG. 1. FIG. 2A is a plan view. FIG. 2B is a cross sectional view taken along line IIB-IIB of FIG. 2A. For convenience, FIG. 2A shows a resistor 60, a wiring section to connect the resistor 60 with an electrode, a detection element 70, and a wiring section to connect the detection element 70 with the electrode. In FIG. 2A, two rectangular regions enclosed in broken lines indicate regions where cavities 41a, 41b are formed on a top surface of the substrate 40. A rectangular region enclosed in a dot-dash line indicates a region where an infrared light absorbing layer 80 is formed.

As shown in FIG. 2B, the sensor chip 30 comprises a substrate 40, a membrane 50, a resistor 60, a detection element 70, and an infrared light absorbing layer 80. A plurality of membranes 50 are provided as thin portions on the substrate 40. The resistor 60 is electrified to generate heat. The detection element 70 detects infrared light. According to the embodiment, the substrate 40 is provided with a membrane 50a and a membrane 50b as the membranes 50. The membrane 50a includes the resistor 60. The membrane 50b includes the detection element 70 and the infrared light absorbing layer 80.

The substrate 40 is a silicon semiconductor substrate. The substrate 40 has cavities 41a and 41b corresponding to regions for forming the membranes 50a and 50b, respectively. According to the embodiment, the cavities 41a and 41b are opened with rectangular regions. The opening areas are gradually reduced toward the top of the substrate 40. On the top surface of the substrate 40, the rectangular regions are formed as indicated by the broken lines in FIG. 2A. The membrane 50a includes the resistor 60. The membrane 50b includes the detection element 70. The membranes 50a and 50b are formed so as to float above the substrate 40. The membranes are thinner than the other parts on the sensor chip 30. In this manner, the resistor 60 is heat-separated from the substrate 40. When the resistor 60 is electrified to generate heat, the light source section 31 can efficiently radiate infrared light. The rectangular regions 41a and 41b indicated by the broken lines in FIG. 2A correspond to regions to form the membranes 50a and 50b in the light source section 31 and the light receiving section 32, respectively.

A silicon nitride layer 42 is provided under the substrate 40. An insulating layer 43 (e.g., silicon nitride layer) is provided on the substrate 40. A silicon oxide layer 44 is provided on the insulating layer 43.

A polysilicon layer 45 is provided on the silicon oxide layer 44. The polysilicon layer 45 comprises a polysilicon layer 45a for the light source section and a polysilicon layer 45b for the light receiving section. The polysilicon layer 45a is provided in the region for forming the membrane 50a. The polysilicon layer 45b is provided from the membrane 50b to a specified range of a thick portion of the substrate 40 outside the membrane 50b. The polysilicon layers 45a and 45b are patterned to specified shapes. of the polysilicon layer 45, the polysilicon layer 45a for the light source section is the resistor 60 constituting the light source section 31. The polysilicon layer 45b for the light receiving section is part of the detection element 70 constituting the receiving section 32. Since the resistor 60 and at least part of the detection element 70 are formed of the same material on the same plane, they can be simultaneously formed in the same process.

The polysilicon layer 45 connects with an aluminum wiring section 47 via an interlayer insulating layer 46 made of BPSG (Boron-doped Phospho-Silicate Glass). The wiring section 47 also comprises a wiring section 47a for the light source section and a wiring section 47b for the light receiving section. The wiring section 47a is connected to the polysilicon layer 45a for the light source section. The wiring section 47b is connected to the polysilicon layer 45b for the light receiving section. The wiring section 47a for the light source section connects the resistor 60 (the polysilicon layer 45a for the light source section) with the electrode. The wiring section 47b for the light receiving section connects between edges of the polysilicon layer 45b for the light receiving section via a contact hole formed in the interlayer insulating layer 46. Along with the polysilicon layer 45b for the light receiving section, the wiring section 47b constitutes a thermocouple functioning as the detection element 70. The wiring section 47b connects the detection element 70 with the electrode.

As shown in FIG. 2A, the thermocouple as the detection element 70 comprises different materials of the polysilicon layer 45b for the light receiving section and the wiring section 47b for the light receiving section. A plurality of sets of the polysilicon layer 45b and the wiring section 47b are alternately and serially disposed (thermopile) to constitute the thermocouple. A hot junction and a cold junction are alternately provided. The hot junction is formed on the membrane 50b having a small thermal capacity. The cold junction is formed on the substrate 40 having a large thermal capacity outside the membrane 50b. Accordingly, the substrate 40 works as a heat sink.

The applicable detection element 70 is constructed as follows. At least part of the detection element 70 is formed on the membrane 50b. The infrared light absorbing layer 80 at least partially covers parts formed on the membrane 50b. The detection element 70 generates electric signals based on thermal changes caused when receiving infrared light. In addition to the above-mentioned thermocouple, the detection element 70 may be a bolometric detection element having a resistor or a pyroelectric detection element having pyroelectrics.

The wiring section 47 has a pad 48 as the electrode at its end. A protective layer 49 (e.g., silicon nitride layer) is provided on the wiring section 47 except the pad 48. Of the pad 48 in FIGS. 2A and 2B, the reference numeral 48a denotes a light source section pad connected to the wiring section 47a for the light source section 31. The reference numeral 48b denotes a light receiving section pad connected to the wiring section 47b for the light receiving section.

The infrared light absorbing layer 80 is formed on the protective layer 49 in the membrane 50b formation region so as to cover at least part of the detection element 70. The infrared light absorbing layer 80 according to the embodiment is produced by sintering the polyester resin containing carbon. The infrared light absorbing layer 80 is formed on the membrane 50b by covering the hot junctions so as to absorb infrared light and efficiently increase the temperature of the hot junctions for the detection element 70. The infrared light absorbing layer 80 is formed with a specified gap with reference to the end of the region for forming the membrane 50b. The applicant discloses this gap (a ratio between the width of the infrared light absorbing layer 80 and the width of the membrane 50b) in Japanese Patent Application Publication No. 2002-365140. Further description is omitted in this embodiment.

The sensor chip 30 having the above-mentioned construction is placed in the case 10. The resistor 60 of the light source section 31 is electrified and is heated to radiate infrared light. The concave mirror 12b reflects the infrared light. The reflected light reaches the light receiving section 32. The infrared light absorbing layer 80 absorbs the infrared light to increase the temperature. As a result, the temperature rises at the hot junction for the deletion 70 disposed under the infrared light absorbing layer 80. By contrast, the cold junction indicates a smaller temperature rise than the hot junction because the substrate 40 works as the heat sink. When the detection element 70 receives the infrared light, a temperature difference occurs between the hot junction and the cold junction. According to this temperature difference, an electromotive force for the detection element 70 changes (Seebeck effect). Based on the changed electromotive force, the detection element 70 detects the infrared light intensity, i.e., the gas density. The thermocouple in FIG. 2A constitutes a thermopile. Output Vout from the detection element 70 is equivalent to the sum of electromotive forces generated from the set of the polysilicon layer 45b for the light receiving section and the wiring section 47b for the light receiving section.

The method of manufacturing the gas sensor 100 will be described with reference to FIGS. 1 and 2B.

First, the method of manufacturing the sensor chip 30 will be described with reference to FIG. 2B.

The silicon nitride insulating layer 43 is formed on all over the silicon substrate 40 by means of the CVD, for example. The insulating layer 43 becomes an etching stopper for etching on the substrate 40 to be described later. The insulating layer 43 is the constituent element of the membranes 50a and 50b. Accordingly, it is important to form the insulating layer 43 by controlling the membrane stress. For this reason, it may be preferable to form the insulating layer 43 as a composite layer comprising the silicon nitride layer and the silicon oxide layer.

For example, the CVD is used to form the silicon oxide layer 44 so as to cover the insulating layer 43. The silicon oxide layer 44 increases the adhesiveness between the polysilicon layer 45a for the light source section and the polysilicon layer 45b for the light receiving section formed immediately on the silicon oxide layer 44. The silicon oxide layer 44 is used as an etching stopper when forming the polysilicon layer 45a for the light source section and the polysilicon layer 45b for the light receiving section by means of etching.

A polysilicon layer is formed on the silicon oxide layer 44 by means of the CVD, for example. Impurities such as phosphorus are implanted for adjustment to obtain a specified resistance value. A photo lithography process is performed for patterning to form the polysilicon layer 45a for the light source section and the polysilicon layer 45b for the light receiving section into specified shapes. At this time, though not shown, thermal oxidation is used to form a silicon oxide layer on the surfaces of the polysilicon layer 45a for the light source section and the polysilicon layer 45b for the light receiving section. The polysilicon layer 45a for the light source section becomes the resistor 60 constituting the light source section 31. The polysilicon layer 45b for the light receiving section becomes part of the detection element 70 constituting the light receiving section 32. Accordingly, the same process can be used to simultaneously form the resistor 60 and at least part of the detection element 70. This makes it possible to simplify the manufacturing process of the sensor chip 30 and improve the positional accuracy of the resistor 60 and the detection element 70. Polysilicon is not the only construction material for the resistor 60 and the detection element 70. The other construction materials are available such as monocrystal silicon implanted with impurities and metal materials such as gold and platinum for forming the resistor 60 and the detection element 70. It is not necessarily use the same process to simultaneously form the polysilicon layer 45a for the light source section and the polysilicon layer 45b for the light receiving section. Different processes may be used to form these polysilicon layers so as to provide corresponding impurity densities.

After formation of the polysilicon layer 45a for the light source section 31 and the polysilicon layer 45b for the light receiving section 32, the CVD method is used to form a BPSG layer on the silicon oxide layer 44 containing these polysilicon layers. The BPSG layer works as the interlayer insulating layer 46. The BPSG layer is then heat-treated at 900 to 1000° C., for example. Heat-treating the BPSG layer as the interlayer insulating layer 46 at a high temperature smoothes steps at the edges of the polysilicon layer 45a for the light source section and the polysilicon layer 45b for the light receiving section. The stepping shape can be gently sloped. Consequently, it is possible to solve a problem of insufficient coverage of the wiring section 47. After the heat treatment, the photolithography is applied to the interlayer insulating layer 46. A contact hole for connection is formed in the regions for forming the membranes 50a and 50b at a position where the polysilicon layers 45a and 45b overlap with the wiring sections 47a and 47b in the lamination direction. As mentioned above, the polysilicon layer 45a is used for the light source section. The polysilicon layer 45b is used for the light receiving section. The wiring section 47a is used for the light source section. The wiring section 47b is used for the light receiving section. The interlayer insulating layer 46 is not limited to the BPSG layer. The interlayer insulating layer 46 may be a silicon nitride layer, a silicon oxide layer, or a composite layer of the silicon oxide layer and the silicon nitride layer.

As a low-resistance metal material, an aluminum layer is formed in the contact hole and on the interlayer insulating layer 46. The photolithography is applied for patterning. This process forms the wiring section 47a for the light source section and the wiring section 47b for the light receiving section. The wiring sections 47a and 47b are electrically connected with the polysilicon layer 45a for the light source section and the polysilicon layer 45b for the light receiving section. Pads are formed as electrodes along with the formation of the wiring section 47a for the light source section and the wiring section 47b for the light receiving section. That is, pads 48a and 48b are formed at the edges of the wiring sections 47a and 47b. The pad 48a is used for the light source section. The pad 48b is used for the light receiving section. In addition to aluminum, the other low-resistance metals such as gold and copper can be used as materials for constructing the wiring section 47a for the light source section and the wiring section 47b for the light receiving section.

The wiring section 47a for the light source section is used as connection between the resistor 60 (the polysilicon layer 45a for the light source section) and the pad 48a for the light source section. The wiring section 47b for the light receiving section makes connection between edges of the polysilicon layer 45b for the light receiving section via the contact hole formed in the interlayer insulating layer 46. Together with the polysilicon layer 45b for the light receiving section, the wiring section 47b constructs the detection element 70 (thermocouple) of the light receiving section 32. The wiring section 47b connects the detection element 70 with the pad 48b.

For example, the CVD method is used to form the protective layer 49 made of silicon nitride. The photolithography is applied for patterning to form apertures for forming the pad 48a for the light source section and the pad 48b for the light receiving section. The apertures expose the pads 48a and 48b from the protective layer 49. The pad 48a for the light source section and the pad 48b for the light receiving section are provided at the edges of the wiring section 47a for the light source section and the wiring section 47b for the light receiving section.

After formation of the protective layer 49, paste is screen-printed on the protective layer 49 in the formation region for the membrane 50b so as to cover the hot junction of the detection element 70. The paste is made of polyester resin containing carbon. The formed layer is sintered to form the infrared light absorbing layer 80.

Finally, for example, plasma CVD method is used to form the silicon nitride layer 42 for an etching mask entirely on the undersurface of the substrate 40. The photolithography is applied to form cavities corresponding to the regions for forming the membranes 50a and 50b on the silicon nitride layer 42. Using potassium hydroxide water solution, for example, anisotropic etching is performed to etch the silicon substrate 40. The etching is performed until exposing the insulating layer 43 provided on the top surface of the substrate 40. The membranes 50a and 50b are formed on the cavities 41a and 41b etched on the substrate 40.

The above-mentioned process forms the sensor chip 30 comprising the light source section 31 and the light receiving section 32. The light source section 31 has the resistor 60 on the membrane 50a for the substrate 40. The light receiving section 32 has at least part of the detection element 70 on the membrane 50b for the substrate 40. The manufacturing method according to the embodiment can use the same process to simultaneously form all elements except the infrared light absorbing layer 80 of the light receiving section 32. Accordingly, the manufacturing process can be simplified. Further, it is possible to improve the accuracy of positions between the light source section 31 and the light receiving section 32.

The general semiconductor process can be used to form the sensor chip 30 according to the embodiment, making it possible to reduce manufacturing costs. The infrared light absorbing layer 80 may be formed after formation of the cavity 11, instead of after formation of the protective layer 49. The above-mentioned manufacturing process may include formation of moisture-absorbent layers such as the silicon oxide layer 44. In this case, the heat treatment may be performed as needed after the layer formation to prevent membrane stress variations due to moisture absorption.

As shown in FIG. 1, the formed sensor chip 30 is bonded to a specified position on the pedestal 11 so that the concave mirror 12b faces the top surface of the substrate 40 where the resistor 60 and the detection element 70 are formed. The specified position should be capable of allowing a large amount of infrared light energy to reach the light receiving section 32. The specified position is determined by the distance between the sensor chip 30 and a reflecting portion of the concave mirror 12b, the reflecting shape (radius) of the concave mirror 12b, and positional relationship between the light source section 31 (resistor 60) and the light receiving section 32 (detection element 70). According to the embodiment, the light source section 31 and the light receiving section 32 are integrated into the sensor chip 30 as a single chip. This determines the positional relationship between the resistor 60 and the detection element 70. The sensor chip 30 can be accurately aligned to the specified position. Consequently, it is possible to decrease variations of the sensor sensitivity.

With the sensor chip 30 fixed to the pedestal 11, the bonding wire 33 is used to electrically connect the pads 48a and 48b, and the terminal 34. The pads 48a and 48b are used for the light source section and the light receiving section on the sensor chip 30, respectively. Using laser welding, for example, the cap 20 is mounted on the pedestal 11 so that the sensor chip 30 is contained in the cap. The cap is previously equipped with the infrared light transmission filter 21a, the band-pass filter 22a, and the partition wall 23. After the cap 20 is mounted, the container 12 is mounted on the pedestal 11. The concave mirror 12b is provided on the inside top of the container 12. In this manner,the gas sensor 100 is formed with the case 10 containing the sensor chip 30.

The substrate 40 has a thick portion (defined to be an intermediate thick portion) between the cavities 41a and 41b, i.e., between the light source section 31 and the light receiving section 32. When the resistor 60 of the light source section 31 generates heat, the intermediate thick portion can suppress (i.e., weaken) transmission of the generated heat directly to the detection element 70 of the light receiving section 32 via the substrate 40 itself or various layers on its surface. That is, heat generated by the resistor 60 can be dissipated to the air or the pedestal 11 via the intermediate thick portion.

While there have been described specific preferred embodiments of the present invention, the present invention is not limited thereto but may be otherwise variously modified to be embodied.

According to the embodiment, the concave mirror 12b exemplifies the reflection member that is disposed opposite to the light source section 31 and reflects infrared light to the light receiving section 32. However, the reflection member is not limited to the concave mirror 12b having a specified radius. The reflection member may be otherwise embodied as a flat mirror, for example.

The position to form the concave mirror 12b is not limited to the top inside of the container 12 constituting the case 10. The concave mirror 12b can be formed at any position which can reflect the infrared light radiated from the light source section 31 to the light receiving section 32 in the case 10 (except the space in the cap 20).

In the example of the embodiment, the sensor chip 30 has cavities 41a and 41b opening on the undersurface of the substrate 40 below the membranes 50a and 50b on the substrate 40. As shown in FIG. 3, however, the sensor chip 30 may be structured to have the cavities 41a and 41b as closed spaces on the undersurface of the substrate 40 below the membranes 50a and 50b on the substrate 40. In this case, the photolithography is first applied to form etching holes (not shown) for etching in the insulating layer 43, the silicon oxide layer 44, the interlayer insulating layer 46, and the protective layer 49. The protective layer 49 is used as an etching mask to selectively etch the substrate 40 below the membranes 50a and 50b through the etching holes. In this manner, the closed cavities 41a and 41b can be formed on the undersurface of the substrate 40. In this case, however, the etching holes for etching are formed in the regions for forming the membranes 50a and 50b. This method causes more restrictions on shapes and areas (along the plane direction) of the resistor 60, the detection element 70, and the infrared light absorbing layer 80 than those on formation of the cavities 41a and 41b by means of selective etching from the undersurface of the substrate 40. FIG. 3 is a sectional view showing a modification of the sensor chip 30 according to the embodiment.

According to the embodiment, two membranes 50a and 50b are formed on one substrate 40. However, the present invention is not limited to the above-mentioned number of membranes formed on the substrate 40. For example, no membrane may be formed on the substrate 40. The light source section 31 and the light receiving section 32 may be formed on a single membrane. There may be provided a plurality of light source sections 31 and light receiving sections 32 and the corresponding number of membranes 50a and 50b.

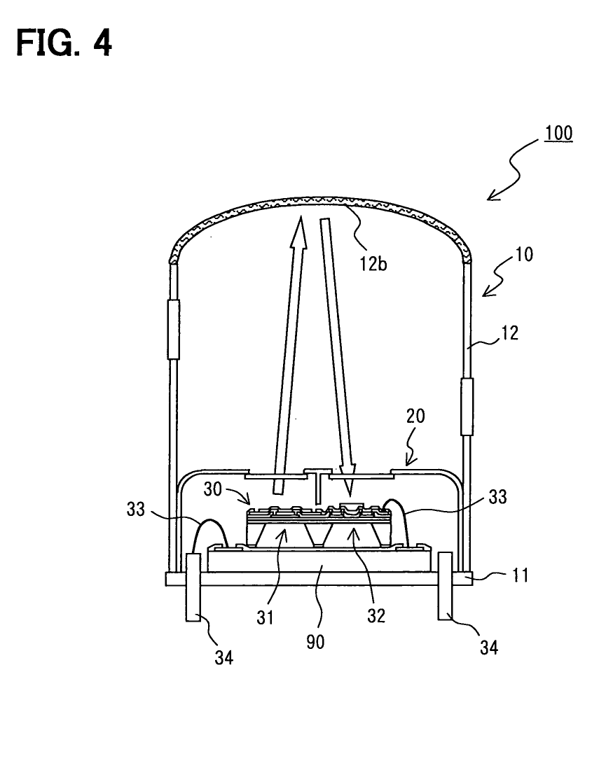

The embodiment has shown the example of bonding the sensor chip 30 on the pedestal 11. On the other hand, the light source section 31 and the light receiving section 32 are integrated into the sensor chip 30 as a single chip. Compared to the prior art (other chips), the sensor chip 30 can reduce the installation space for the light source section 31 and the light receiving section 32 in the case 10. As shown in FIG. 4, it is possible to dispose a circuit chip 90 for the light source section 31 and the light receiving section 32 in a free space in the case 10 without increasing the size of the case 10. The circuit chip 90 can be integrated with the gas sensor 100. The circuit chip 90 contains a constant current circuit to supply current to the resistor 60 of the light source section 31, a processing circuit to process output from the light receiving section 31, and the like. Specifically, the circuit chip 90 is fixed to the pedestal 11 as shown in FIG. 4. The sensor chip 30 is stacked on the circuit chip 90. The bonding wire 33 may then be used to make electrical connection between the sensor chip 30 and the circuit chip 90 as a circuit substrate and between the circuit chip 90 as the circuit substrate and the terminal 34. FIG. 4 illustrates a modification of the gas sensor 100 according to the embodiment and shows only parts of the bonding wire 33 for convenience.

The embodiment has shown the example of using the semiconductor substrate made of silicon as the substrate 40 constituting the sensor chip 30. However, the substrate 40 is not limited to semiconductor substrates. Further, for example, a glass substrate and the like may be used for the substrate 40.

Such changes and modifications are to be understood as being within the scope of the present invention as defined by the appended claims.

1. An infrared gas sensor comprising:
an infrared light source having a resistor for emitting an infrared light by heating the resistor;
an infrared light sensor having a detection device for generating an electric signal in accordance with a temperature change of the detection device corresponding to the infrared light in a case where the sensor receives the infrared light;
a reflection member for reflecting the infrared light emitted from the light source to introduce the infrared light to the sensor;
a casing for accommodating the light source, the light sensor, and the reflection member; and
a substrate,
wherein the reflection member faces the light source, and
wherein the resistor and the detection device are disposed on the substrate.

2. The infrared light gas sensor according to claim 1,
wherein the reflection member is a concave mirror.

3. The infrared light gas sensor according to claim 1,
wherein the substrate includes a plurality of membranes as a thin portion of the substrate, and
wherein the resistor and the detection device are disposed on different membranes, respectively.

4. The infrared light gas sensor according to claim 3,
wherein the detection device is a thermocouple including a measurement junction and a reference junction,
wherein the measurement junction is disposed on one membrane, and
wherein the reference junction is disposed on the substrate except for the membrane.

5. The infrared light gas sensor according to claim 1,
wherein the detection device has a part made of the same material as the resistor.

6. The infrared light gas sensor according to claim 1,
wherein the detection device has a part, which is disposed on the same plane as the resistor.

7. The infrared light gas sensor according to claim 1,
wherein the substrate is a semiconductor substrate, and
wherein the resistor and the detection device are disposed on the semiconductor substrate through an insulation film.

8. The infrared light gas sensor according to claim 1, further comprising:
a circuit chip,
wherein the substrate having the resistor and the detection device is mounted on the circuit chip so that the circuit chip with the substrate is disposed inside the casing.
